(19) United States
(12) Patent Application Publication
(10) Pub. No.: US 2010/0225467 A1
(43) Pub. Date: Sep. 9, 2010

(54) METHOD AND APPARATUS FOR DETECTING LEAKS IN SURGICAL GLOVES

(75) Inventors: Adrian Robert BOWLES, Farnborough (GB); Timothy Rupert Charles JARMAN, Farnborough (GB); Bernard Robert MONEY, Farnborough (GB)

Correspondence Address: OLIFF & BERRIDGE, PLC, P.O. BOX 320850, ALEXANDRIA, VA, 22320-4850, US

(73) Assignee: QinetiQ Limited, London (GB)

(21) Appl. No.: 12/708,137

(22) Filed: Feb. 18, 2010

(30) Foreign Application Priority Data
Mar. 5, 2009 (GB) 0903783.9

(51) Int. Cl. G08B 1/00

(52) U.S. Cl. 340/532

(57) ABSTRACT

Apparatus for detecting failure of a protective barrier between a first object and a second object is provided. The apparatus includes a transmitter assembly for transmitting an alternating electrical signal through the first object and a receiver assembly, wherein the receiver assembly is configured to receive the alternating electrical signal through the second object upon breach of the protective barrier. In a preferred embodiment, the first object is a patient undergoing surgery and/or medical treatment, the second object is a healthcare worker such as a surgeon and the protective barrier is a glove such as a surgical glove. The transmitter and/or receiver assemblies typically include transmitter or receiver electronics and signal connections, and optionally, the electronics and connections can together form integral transmitter and/or receiver assemblies. A return path can be provided for the transmitted signal.

This invention relates generally to a system and method for detecting failure of protective barriers such as gloves and clothing, especially protective barriers used by workers exposed to hazardous liquids. More specifically, the invention relates to a system and method for warning healthcare workers that the integrity of surgical gloves has been compromised.

Apparel such as surgical gloves plays a vital role in preventing the transmission of liquid-borne pathogens from a patient to a healthcare worker. However, factors such as the use of sharp instruments, and the necessity for using thin, sensitive materials (particularly in the case of surgical gloves) can lead to holes, rips and so on in the protective barrier. Damage is often unnoticed, either because it happens during use or because the damage is simply not visible to the human eye. Accordingly, there is a need for methods for monitoring the integrity of surgical gloves and other apparel, preferably during the course of a surgical or other medical procedure.

U.S. Pat. No. 4,206,631 to Nysse et al describes a method of testing an inflatable product such as a surgical glove for leakages and weak spots by applying a gas pressure, and U.S. Pat. No. 5,493,899 to Beck at al discloses an immersion testing method for an elastomeric personal barrier such as a glove. Both methods monitor whether or not a glove is intact prior to use, and are not suitable for detecting damage which might occur during use.

WO 91/05518 to Albin et al, on the other hand, discloses a method for electrically detecting a leak in a rubber glove which can be used both prior to surgery and during surgery. However, the method requires the surgeon's hands to be placed in a receptacle containing an electrolyte and thus, is not suitable for continuous monitoring. Similarly, U.S. Pat. No. 5,204,632 to Leach and U.S. Pat. No. 5,351,008 to Leach at al disclose electrical leak testing methods for use during surgical and/or diagnostic procedures which require the practitioner's hands to be placed, respectively, in a flowing sterile saline solution and an electrolyte-containing pouch. Again, the methods are unsuitable for continuous monitoring.

Protective apparel such as, for example, latex surgical gloves, is generally electrically insulating. Thus, various methods have been proposed for continuously monitoring the integrity of a protective barrier worn by a surgeon based on the principle of establishing a circuit between the surgeon, the patient and a central processing unit, and measuring the change in resistance and/or conductivity of the circuit associated with a breach of the insulating protective barrier. (The circuit may be an AC circuit or a DC circuit.) U.S. Pat. No. 4,321,925 to Hoborn at al, WO 90/13102 to Langdon, U.S. Pat. No. 5,114,425 to Williams at al, U.S. Pat. No. 5,430,434 to Lederer at al, U.S. Pat. No. 5,389,097 to Bennett at al and WO 97/09628 to Thompson are all examples of methods and apparatus in which a circuit of this type is established. However, although the integrity of the glove barrier can be monitored continuously during use, the methods suffer from the disadvantage that apparatus can be unwieldy. Moreover, undesirable physical restrictions are usually placed on the surgeon and/or patient by linking them via wires and/or conducting floor pads.

Accordingly, there exists a need for an improved system and method for detecting failure in the barrier protection offered by surgical gloves and suchlike.

According to a first aspect of the invention, there is provided apparatus for detecting failure of a protective barrier between a first object and a second object, said apparatus comprising a transmitter assembly for transmitting an alternating electrical signal through the first object and a receiver assembly, wherein the receiver assembly is configured to receive said alternating electrical signal through the second object upon breach of the protective barrier.

Preferably, either the first object or the second object is a human worker, more preferably a human worker wearing a protective barrier such as a gown or glove.

The object of the invention is to transmit an alternating electrical signal—also known as an AC signal—through an object on one side of the protective barrier and receive the signal through an object on the other side of the barrier when the barrier is breached, damaged or otherwise compromised (so that an alarm can be activated) and it is immaterial to the operation of the invention which side of the barrier the transmitter and receiver assemblies are positioned, provided that they are on opposite sides. Hence, in one embodiment of the invention, the first object is a potentially hazardous article, animal or human and the second object is a human worker, and in a second, alternative embodiment, the first object is a human worker and the second object is a potentially hazardous article, animal or human. In other words, either the first object or the second object can be a human worker and the other object can be a potentially hazardous article, animal or human.

Accordingly, the apparatus of the invention can be arranged with the transmitter assembly on the potentially hazardous article, animal or human and the receiver assembly on the human worker, or vice versa. Conveniently (but not necessarily) the receiver assembly is positioned on the human worker for ease of monitoring an alarm or warning signal.

Under normal, safe working conditions, the protective barrier provides physical isolation between the first object and the second object. Typically, protective barriers also offer electrical isolation, which can be compromised once physical damage occurs. In the present invention, breach of the protective barrier means that an electrical signal path is established between the first object and the second object, thereby allowing the alternating electrical signal to pass through the second object. The breach may arise by fluid passing through a damaged portion (tear, rip etc) of the protective barrier and/or by the second object coming into contact with the first object through a damaged portion. Hence, the breach may be a wet breach or a dry breach.

The invention can be used in any situation where a hazardous fluid might flow from an object containing, or otherwise comprising, said fluid to a worker upon breach of a protective barrier, thereby contaminating, or potentially contaminating, the worker with the hazardous fluid through said breach. However, the invention is particularly suitable for monitoring the integrity of a protective barrier between one human and another, such as, for example, might be encountered in healthcare situations. In such an application, the hazardous fluid would typically be a biological fluid which may contain pathogens. Preferably, therefore, either the first or second object is a patient (typically a patient undergoing a medical and/or surgical procedure), the other object is a healthcare worker (such as, for example, a surgeon, doctor, dentist, nurse or other medical practitioner) and the protective barrier is an item of surgical apparel (such as, for example, a gown or glove). Most preferably, the invention is used to detect failure of a surgical glove during a surgical procedure, thereby providing the surgeon with timely warning of said failure and potential and/or actual breach of the protective barrier, in which case either the first or second object is a patient, the other object is a surgeon and the protective barrier is a surgical glove.

The apparatus of the invention comprises a transmitter assembly for transmitting an alternating, preferably low power electrical signal through the first object, and a receiver assembly configured to receive the transmitted signal through the second object. In use, the transmitter assembly is connected to the first object such that the alternating electrical signal can be transmitted through said object and, similarly, the receiver assembly is connected to the second object such that, upon establishment of a signal path between the first and second objects, the alternating electrical signal can be received through the second object. Typically, therefore, the transmitter assembly will be in electrical contact with the first object and the receiver assembly will be in electrical contact with the second object.

The invention differs from the prior art in that the apparatus comprises a separate AC transmitter and receiver. The transmitter and receiver do not require direct connection and an electrical circuit is not established. Hence, the apparatus of the invention is akin to a communications transmitter/receiver assembly, with the protective barrier acting to block communication between the transmitter/receiver pair. Put another way, the transmitter assembly broadcasts or propagates an AC signal through the first object and the receiver assembly picks up the broadcast signal through the second object if the protective barrier is compromised.

Under normal conditions, the first object is electrically isolated from the second object by means of the protective barrier—which barrier is typically worn by a human worker acting as the first or second object—and hence, the receiver is unable to receive the transmitted signal. Should the protective barrier become damaged, however, an electrical signal path can be established between the first object and the second object (by fluid passing through the a gap, tear, hole or suchlike in the barrier, and/or by the first object coming into direct contact with the second object through the gap, tear, hole etc) and the receiver is able to sense the transmitted signal. Upon receipt of said signal, an alarm can be activated to provide a warning that the protective barrier is no longer secure.

The inventors have shown that the apparatus of the invention can detect the failure of a barrier positioned between a transmitter assembly and a receiver assembly without necessarily providing a return path for the transmitted AC signal. However, preferably a return path is provided so that the receiver is better able to detect the transmitted signal. In this way, more reliable operation of the apparatus in some situations can be obtained. One way of providing an AC signal return path is to provide a conductive return path using, for example, specialised clothing such as conductive shoes and/or conductive garments. A suitable resistance for the conductive return path would be around 2 MOhms. Alternatively, or in addition to providing a conductive return path, a radiated return path can be provided by connecting the receiver ground to adjacent conductive structures, such as, for example adjacent metal structures. It might also be desirable to connect an insulated lead to the transmitter ground circuit to compensate for undesirable factors such as signal damping effects that might be caused by the first and/or second object, and/or the working environment.

The invention provides continuous monitoring of barrier integrity and, moreover, provides a number of important advantages over prior art systems, including convenience, compact size, ease of use and real time, continuous assessment of barrier integrity. Preferably, the apparatus is configured to avoid the need for obstructive connectors, grounding leads and/or grounding mats, thereby further simplifying the configuration and providing freedom of movement. Another important advantage of the invention is that a signal path can, in some situations, be established by a dry breach of the protective barrier, in other words, prior to leakage of fluid through the damaged area. Thus, warning can be provided prior to actual fluid contamination. This contrasts with prior art direct current techniques whereby a wet breach of the barrier is generally required to activate a response.

The transmitter assembly typically comprises electronics for generating and controlling an AC signal output, and means for connecting the signal output to the first object such that the signal is transmitted through said object. Any suitable means can be used for connecting the signal output to the first object, including conducting leads, straps, bands and/or pads. In a particularly preferred embodiment, the connection means comprises a band, more preferably a conductive band such as that typically used in ESD grounding applications. Optionally, a conducting adhesive and/or a conductive gel can be used to provide and/or enhance electrical contact between the transmitter connection means and the first object.

In the particular case of a patient undergoing a medical procedure such as a surgical operation—or indeed, whenever the transmitter assembly is connected to a human—the connection between the transmitter assembly and (depending on the mode of use) the patient or healthcare worker is ideally non-invasive, so contact is preferably made with the patient or healthcare worker's skin. Conveniently, the signal output is connected to the skin using adhesive contacts (such as, for example, suitably adapted ECG pads) or conductive bands. Optionally, a conductive gel can be used to improve the contact between the transmitter assembly and the skin.

The transmitter electronics and signal connection means can be separate components of the transmitter assembly, in which case the transmitter electronics can conveniently be housed in a transmitter control unit mounted at any convenient location on, near or even remote from the first object. In a preferred embodiment of the invention, an AC signal output of a transmitter control unit is connected to the first object by means of a connecting lead and a conductive band.

Alternatively, the transmitter electronics and connection means can together form a self-contained, integral transmitter assembly which can be mounted directly onto the first object, preferably an external surface thereof. Hence, in another preferred embodiment of the invention, the transmitter assembly takes the form of a conductive band comprising integral transmitter electronics, which band can be attached to the first object. For medical procedures, the transmitter band is conveniently (but not necessarily) worn at the wrist or ankle of the patient or healthcare worker. In yet another preferred embodiment, an integral transmitter assembly takes the form of an adhesive pad, preferably a suitably adapted ECG-type contact.

Similarly, the receiver assembly typically comprises electronics for receiving and detecting and/or analysing an alternating electrical signal, and means for connecting a signal input to the second object such that an alternating electrical signal can be received through said object. Any suitable means can be used for connecting the signal input to the second object, including conducting leads, straps, bands and/or pads, but preferably the connection means comprises a band, more preferably a conductive band. Optionally, a conducting adhesive and/or a conductive gel can be used to provide and/or enhance electrical contact between the receiver connection means and the second object.

In the case of a patient undergoing a medical procedure such as a surgical operation—or in any situation where the second object is a human—the connection between the receiver assembly and the patient or healthcare worker is again ideally non-invasive, so contact is preferably made with the patient or healthcare worker's skin. Conveniently, the signal input of the receiver electronics is connected to the skin using adhesive contacts (such as, for example, suitably adapted ECG pads) or conductive bands. Optionally, a conductive gel can be used to improve the contact between the transmitter assembly and the skin.

The receiver electronics and means for connecting the signal input of the receiver electronics to the second object can be separate components of the receiver assembly, in which case the receiver electronics can conveniently be housed in a receiver control unit mounted at any convenient location on, near or remote from the second object. In a preferred embodiment of the invention, the signal input of a receiver control unit is connected to the second object by means of a connecting lead and a conductive band.

Alternatively, the receiver electronics and connection means can together form an integral receiver assembly which can be mounted directly onto the second object, preferably an external surface thereof. Hence, in another preferred embodiment of the invention, the receiver assembly takes the form of a conductive band comprising integral receiver electronics, which band can be attached to the second object. For medical procedures, the receiver band is conveniently (but not necessarily) worn at the wrist or ankle of the patient or healthcare worker. In yet another preferred embodiment, an integral receiver assembly takes the form of an adhesive pad, suitably an ECG-type contact configured without trailing leads.

The preferred self-contained, integral receiver assembly may also comprise an alarm, conveniently a tactile, audio and/or visual alarm.

One of the advantages of the apparatus of the invention is its potential convenience and simplicity. As discussed above, the transmitter assembly can be a compact, preferably self-contained or integral unit capable of being mounted nearby, or even directly onto, a first object. Similarly, the receiver assembly can be a compact, preferably self-contained or integral unit capable of being mounted nearby, or even directly onto, a second object.

Advantageously, the receiver and/or transmitter assemblies each comprise their own power supply. Any suitable power supply can be used for the transmitter and receiver assemblies, but for convenience a battery can be used. Suitably, the power supply for a self-contained transmitter assembly and/or receiver assembly comprising integral control electronics and connection means is a coin cell, or other compact power supply.

Any alternating electrical signal can be used in the invention, but preferably the electrical signal is selected from the group consisting of a sine wave, a square wave, a sawtooth wave, or any combination thereof. More preferably, the signal is a sine wave. Optionally, the alternating electrical signal is AC coupled so as to block any DC component.

Desirably, the alternating electrical signal, preferably a low power signal, is selected so as to provide sufficient discrimination from likely background signal levels and/or noise. For an apparatus suitable for use in medical procedures, an alternating electrical signal is preferred having an open circuit RMS amplitude in the range 5V to 200V, more preferably 10V to 150V RMS and even more preferably 10V to 130V RMS, and a frequency in the range 0.1 kHz to 50 kHz, more preferably 1 kHz to 10 kHz and even more preferably 3 kHz to 7 kHz. Suitably, the impedance lies in the megaOhm range, typically around 1 MOhm.

Optionally, the alternating electrical signal transmitted by the transmitter assembly is digitally encoded, which is advantageous because it can provide noise immunity and a low probability of false detection. Alternatively, the alternating electrical signal comprises a specific narrow band analogue frequency which can be readily distinguished from background electrical signals.

The receiver assembly preferably comprises receiver electronics configured to receive the alternating electrical signal, and is desirably capable of distinguishing said signal from any background signals. Optionally, a threshold signal level can be set so as to reduce the likelihood of false alarms.

A second aspect of the invention provides a method of detecting failure of a protective barrier between a first object and a second object, said method comprising the steps of transmitting an alternating electrical signal through the first object and receiving said signal through the second object upon breach of the protective barrier.

The method of the invention involves positioning a transmitter assembly on, or otherwise placing a transmitter into contact with, a first object, such that an alternating electrical signal is transmitted through said object, and positioning a receiver assembly on, or otherwise placing a receiver into contact with, a second object, such that the alternating electrical signal can be received through the second object upon breach of the protective barrier. In other words, if the first object comes into electrical contact with the second object because the protective barrier is damaged, the receiver assembly is able to detect the alternating electrical signal through the barrier and—if required—activate a tactile, audio and/or visual alarm. Hence, the method enables continuous monitoring of barrier integrity.

In a third aspect there is provided a method of detecting failure of a protective barrier between a first object and a second object, said method comprising the steps of positioning a transmitter assembly in contact with the first object such that an alternating electrical signal is transmitted through the first object and positioning a receiver assembly in contact with the second object, wherein the receiver assembly is capable of receiving the transmitted signal through the second object upon breach of the protective barrier.

In a fourth aspect of the invention there is provided a transmitter assembly for use in an apparatus for detecting failure of a protective barrier between a first object and a second object, said transmitter assembly comprising means for generating an alternating electrical signal and means for connecting the signal to the first object such that the signal is transmitted through said object. The means for generating the alternating electrical signal and means for connecting the signal to the first object can form a self-contained, integral transmitter assembly suitable for mounting directly onto the first object.

In a fifth aspect of the invention there is provided a receiver assembly for use in an apparatus for detecting failure of a protective barrier between a first object and a second object, said receiver assembly comprising means for receiving and detecting and/or analysing an alternating electrical signal and means for connecting the signal input to the second object such that the signal can be received through said object. The means for receiving and detecting and/or analysing the alternating electrical signal and means for connecting the signal input to the second object can form a self-contained or integral receiver assembly suitable for mounting directly onto the second object.

In a sixth aspect there is provided a kit for detecting failure of a protective barrier between a first object and a second object, said kit comprising a transmitter assembly and a receiver assembly as described above and, optionally, a tactile, audio and/or visual alarm.

In a yet another aspect there is provided the use of an AC transmitter and an AC receiver in an apparatus or method for detecting failure of a protective barrier between a first object and a second object, and in a final aspect there is provided the use of an AC transmitter and an AC receiver in an apparatus or method for detecting failure of a glove, preferably a surgical glove, during a medical procedure.

Any feature disclosed in respect of one aspect of the invention may be applied to any other aspects of the invention, in any appropriate combination. In particular, apparatus aspects may be applied to method aspects, and vice versa.

The invention extends to an apparatus and method substantially as herein described with reference to the accompanying drawings.

The invention will now be described, purely by way of example, with reference to the accompanying drawings, in which;

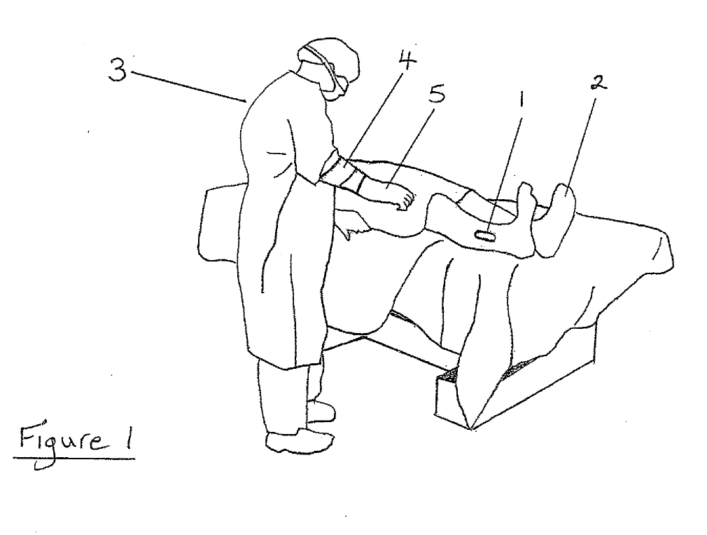

FIG. 1 is a schematic representation of the apparatus of the invention in use;

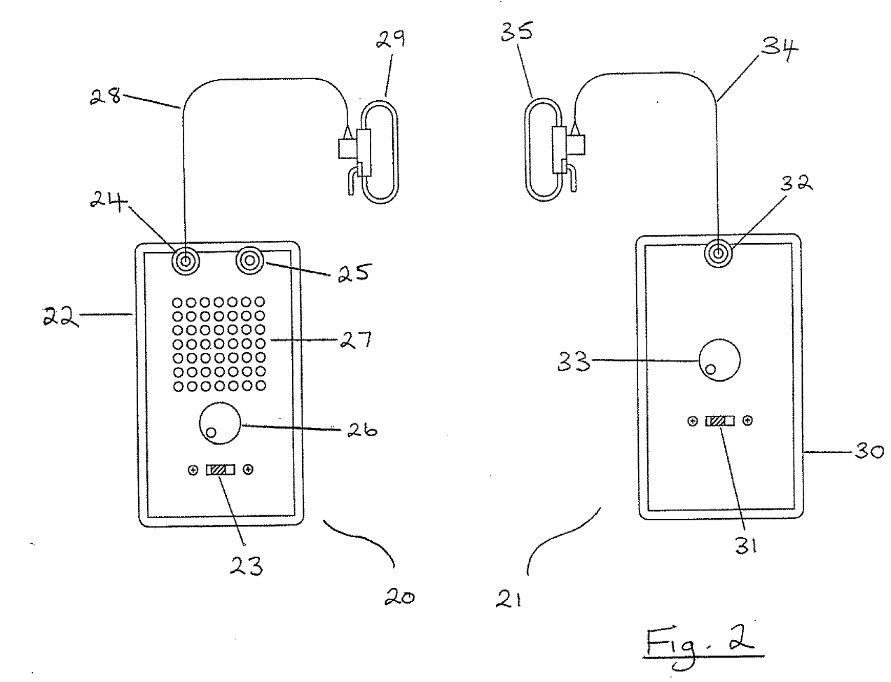

FIG. 2 is a schematic representation of one embodiment of the apparatus of the invention;

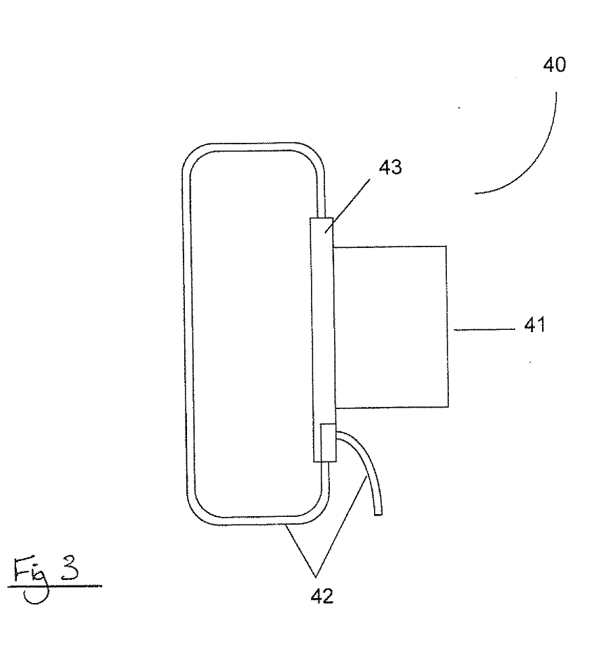

FIG. 3 is a schematic representation of an integral transmitter or receiver assembly suitable for use in the apparatus of the invention;

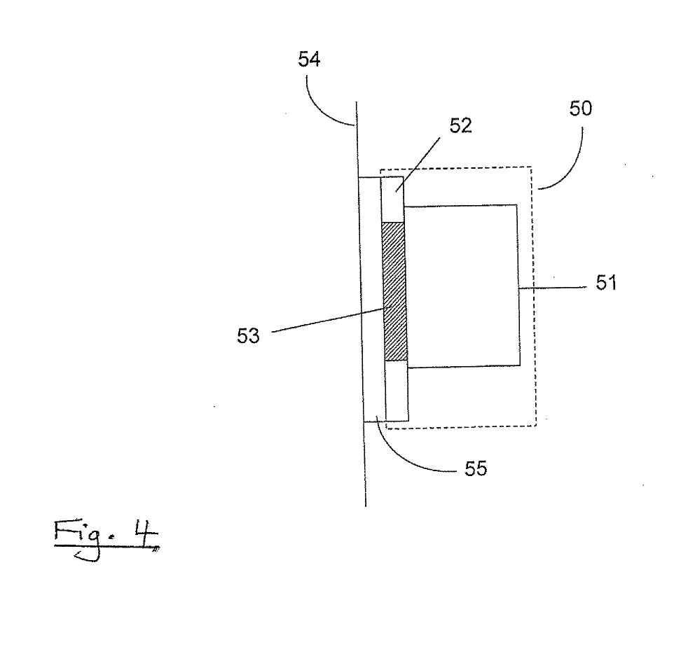

FIG. 4 is a schematic representation of another integral transmitter or receiver assembly suitable for use in the apparatus of the invention;

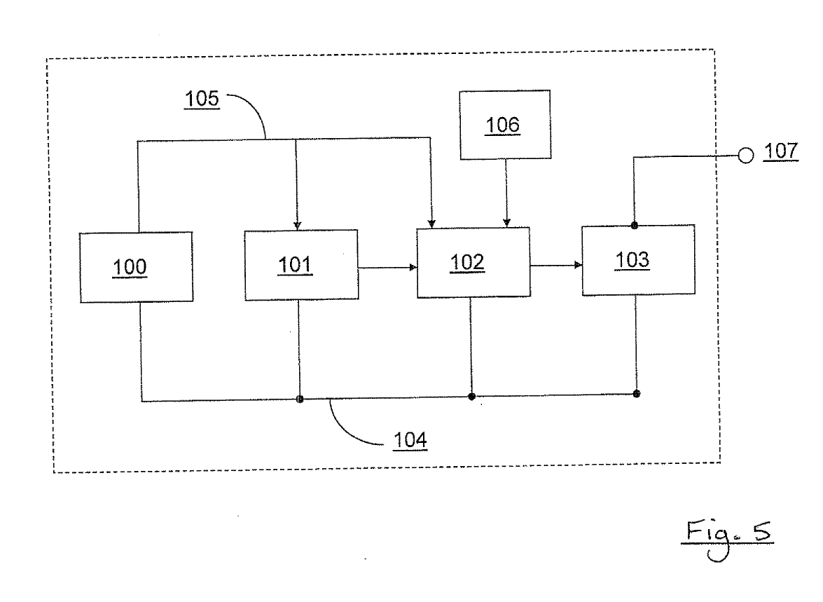

FIG. 5 is a schematic diagram showing the basic components of a transmitter circuit suitable for use in the invention;

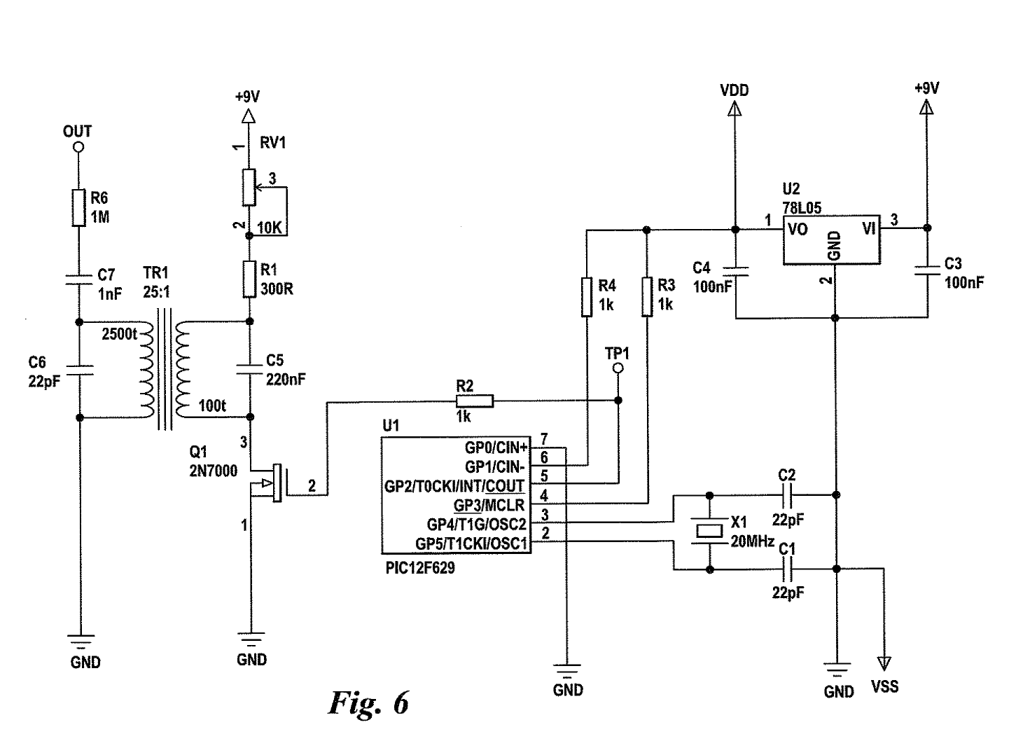

FIG. 6 is a circuit diagram for the transmitter control unit of the embodiment shown in FIG. 2;

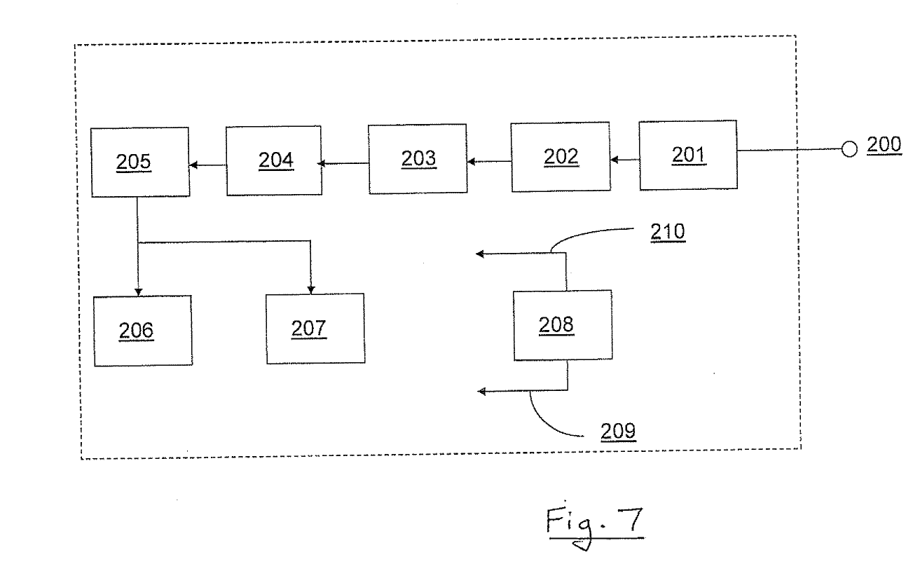

FIG. 7 is a schematic diagram showing the basic components of a receiver circuit suitable for use in the invention; and

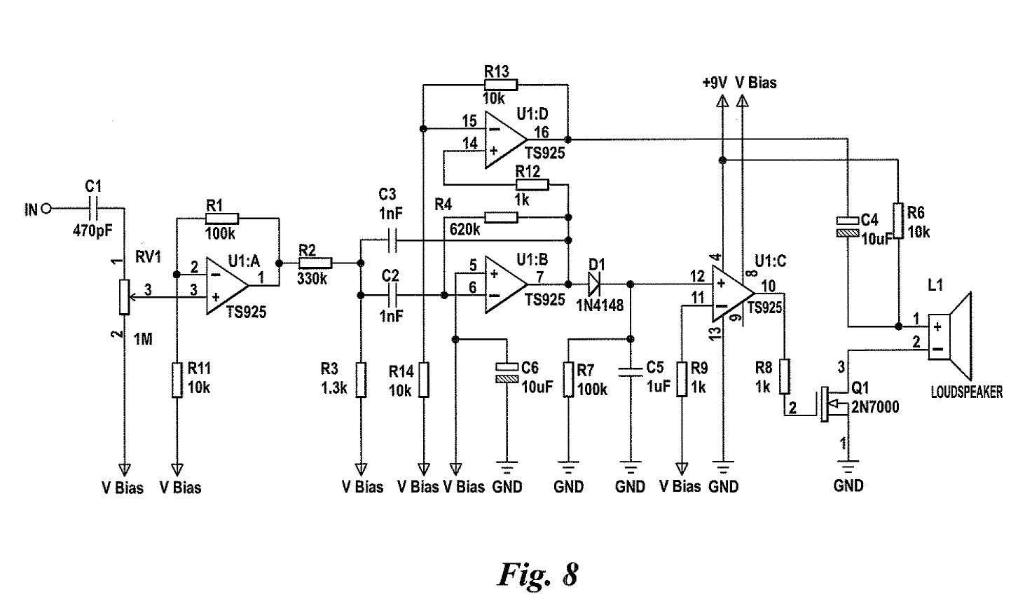

FIG. 8 is a circuit diagram for the receiver control unit of the embodiment shown in FIG. 2.

FIG. 1 illustrates one preferred embodiment of the invention in use. A transmitter 1 (which may be an integral transmitter assembly or, alternatively, transmitter connection means connected to a remotely positioned transmitter control unit) is mounted on a patient 2 undergoing a surgical procedure. The transmitter transmits a safe, preferably low power alternating electrical signal through the patient, preferably by means of direct contact with the patient's skin. The human skin has a finite level of electrical resistance which permits the transmission of the alternating electrical signal across the body. One suitable waveform is a sine wave having a frequency around 5 kHz and an amplitude of 20V.

The surgeon 3 wears a receiver 4 (which may be an integral receiver assembly or, alternatively, receiver connection means connected to a remotely positioned receiver control unit) held in place by an arm or wristband. The receiver is electrically connected to the surgeon's skin and ‘listens’ for the arrival of the signal being transmitted by the transmitter 1 attached to the patient 2. The surgeon's gloves 5 are made of an electrically insulating material such as latex or nitrile rubber and accordingly, do not, whilst intact, permit the transmission of the alternating electrical signal from the patient to the surgeon. However, if there is any failure in the electrically insulating, protective barrier offered by the surgical glove 5 during use, a transmission path forms between the patient 2 and the surgeon 3. Upon breach of the surgical glove barrier, therefore, the transmitted signal is received by the surgeon's receiver 4 and an alarm (not shown) can be activated. The alarm provides a warning that the barrier is breached and that the surgeon could be at risk from infection from the patient's bodily fluids.

In alternative embodiments, the transmitter 1 could be mounted on the wrist or arm, or any other convenient part, of the patient's body. Similarly, the receiver 4 can be mounted at any other convenient location on the surgeon's body. Moreover, the apparatus could be implemented in an alternative mode of use whereby the transmitter 1 is mounted on, worn on or otherwise attached to the surgeon 3 and the receiver 4 is mounted on, worn on or otherwise attached to the patient 2.

FIG. 2 illustrates apparatus suitable for detecting failure of a protective barrier between a healthcare worker and a patient comprising a receiver assembly 20 and a transmitter assembly 21. The receiver assembly 20 comprises a receiver control unit 22 having a power switch 23, a signal input 24, an optional ground connector 25, a sensitivity control 26 and an audible alarm 27. The signal input 24 of control unit 22 is connected to the healthcare worker or patient by means of a 1 MOhm lead 28 and a conductive band 29 which can be worn at any convenient location (such as, for example, the wrist or ankle). The receiver control unit 22 can be mounted at any suitable location, either on the healthcare worker or patient, or remote from the healthcare worker or patient.

The transmitter assembly 21 comprises a transmitter control unit 30 having a power switch 31, an AC signal output 32 and a control 33 for adjusting the signal output level. The signal output 32 of transmitter control unit 30 is connected to the healthcare worker or patient by means of a 1 MOhm lead 34 and a conductive band 35. Again, the transmitter control unit 30 can be mounted at any suitable location, either on the healthcare worker or patient, or remote from the healthcare worker or patient, and the conductive band 35 can be worn at any convenient location, for example at the wrist or ankle.

FIG. 3 illustrates an alternative configuration for the transmitter assembly and/or receiver assembly in which a unit 41 housing the transmitter or receiver electronics is directly attached to a conducting wristband 42 so as to form an integral transmitter or receiver assembly 40 which can by worn by a patient or healthcare worker. The wristband optionally comprises adjustment means 43 so as to ensure good contact and/or secure positioning.

FIG. 4 illustrates another possible configuration for an integral transmitter and/or receiver assembly 50 in which a unit 51 housing the transmitter or receiver electronics is directly attached to an adhesive pad 52 (such as, for example, a suitably adapted ECG pad) having a contact region 53 for carrying the AC signal. In use, the integral assembly can be directly attached to the skin 54 of the healthcare worker or patient or, if desired, a layer of conducting adhesive or gel 55 can be used to improve the adhesion and/or electrical contact.

FIGS. 2 to 4 are schematic diagrams for illustrative purposes and are not necessarily to scale.

FIG. 5 is a schematic diagram showing the basic components of a transmitter circuit suitable for use in the invention. The transmitter electronics comprise a battery 100 providing DC power 105 to an oscillator 101 and an output driver 102. The DC signal is converted to an AC signal by means of transformer 103 and a single contact output 107 is provided. The output driver is provided with an optional power level control 106. The battery 100, oscillator 101, output driver 102 and transformer 103 are connected to local ground 104.

FIG. 6 is a circuit diagram for the transmitter control unit of the embodiment of the invention shown in FIG. 2.

FIG. 7 is a schematic diagram showing the basic components of a receiver circuit suitable for use in the invention. The receiver electronics comprise single contact input 200 connected via an optional sensitivity control 201 to a bandpass filter 202, an amplifier 203, a detector 204 and an optional threshold switch 205. Audible and/or visual warning can be provided by means of an optional loudspeaker 206 and/or LED output 207. A battery 208 or other DC power supply provides DC power 210 and local ground 209 to all stages.

FIG. 8 is a circuit diagram for the receiver control unit of the embodiment of the invention shown in FIG. 2.

It will be understood that the present invention has been described above purely by way of example, and modification of detail can be made within the scope of the invention. Each feature disclosed in the description, and (where appropriate) the claims and drawings may be provided independently or in any appropriate combination.

The invention has been described with particular reference to detecting the failure of surgical gloves. It will be understood that this is not intended to be limiting and the invention may be used more generally with protective barriers. Another application, for example, might be monitoring barrier integrity in glove boxes. Yet another application might be manual handling of a bottle or other article containing a hazardous fluid.

The invention can also be used to monitor the integrity of barriers for separating one fluid from another, such as, for example, a diaphragm in a control valve (preferably a process control valve) or a diaphragm pump. In that particular case, the protective barrier is a diaphragm and, typically, the first object and second object are two sides of a control valve or diaphragm pump housing.

1. Apparatus for detecting failure of a protective barrier between a first object and a second object, said apparatus comprising a transmitter assembly for transmitting an alternating electrical signal through the first object and a receiver assembly, wherein the receiver assembly is configured to receive said alternating electrical signal through the second object upon breach of the protective barrier.

2. Apparatus according to claim 1, wherein the first object is a potentially hazardous article, animal or human and the second object is a human worker.

3. Apparatus according to claim 2, wherein the first object is a patient undergoing surgery and/or medical treatment and the second object is a healthcare worker.

4. Apparatus according to claim 1, wherein the first object is a human worker and the second object potentially hazardous article, animal or human.

5. Apparatus according to claim 4, wherein the first object is a healthcare worker and the second object is a patient undergoing surgery and/or medical treatment.

6. Apparatus according to claim 1, wherein the protective barrier is a protective garment.

7. Apparatus according to claim 1 further comprising an alarm capable of being activated upon receipt of the transmitted signal.

8. Apparatus according to claim 7, wherein the alarm provides a tactile, audio and/or visual warning signal.

9. Apparatus according to claim 1, wherein the transmitter assembly comprises transmitter electronics having an AC signal output and means for connecting the signal output to the first object.

10. Apparatus according to claim 9, wherein the transmitter electronics and means for connecting the signal output to the first object together form an integral transmitter assembly.

11. Apparatus according to claim 9, wherein the means for connecting the signal output to the first object comprises a conductive band.

12. Apparatus according to claim 1, wherein the receiver assembly comprises receiver electronics having a signal input and means for connecting the input to the second object.

13. Apparatus according to claim 12, wherein the receiver electronics and means for connecting the signal input to the second object together form an integral receiver assembly.

14. Apparatus according to claim 12, wherein the means for connecting the signal input to the second object comprises a conductive band.

15. Apparatus according to claim 1, wherein the alternating electrical signal has a frequency in the range 0.1 kHz to 50 kHz.

16. Apparatus according to claim 1, wherein the alternating electrical signal has an RMS amplitude in the range 5V to 200V.

17. Apparatus according to claim 1, wherein the electrical signal is selected from the group consisting of a sine wave, a square wave and a sawtooth wave.

18. Apparatus according to claim 1, wherein the alternating electrical signal is digitally encoded.

19. Apparatus according claim 1, wherein a return path is provided for the transmitter signal.

20. A method of detecting failure of a protective barrier between a first object and a second object, said method comprising the steps of transmitting an alternating electrical signal through the first object and receiving said signal through the second object upon breach of the protective barrier.

21. A method according to claim 20, wherein receipt of the transmitted signal activates an alarm.

22. A method according to claim 20, wherein the breach of the protective barrier is by means of fluid contamination.

23. A method of detecting failure of a protective barrier between a first object and a second object, said method comprising the steps of positioning a transmitter assembly in contact with the first object such that an alternating electrical signal is transmitted through the first object and positioning a receiver assembly in contact with the second object, wherein the receiver assembly is capable of receiving the transmitted signal through the second object upon breach of the protective barrier.
